(19) United States
(12) Patent Application Publication
(10) Pub. No.: US 2007/0102584 A1
(43) Pub. Date: May 10, 2007

(54) Kite with releasable accessory, and release mechanism

(75) Inventors: Jim Christianson, Colchester, CT (US); Randy Tom, El Cajon, CA (US)

Correspondence Address: TOPE-MCKAY & ASSOCIATES, 23852 PACIFIC COAST HIGHWAY #311, MALIBU, CA, 90265, US

(73) Assignee: JAKKS PACIFIC, INC.

(21) Appl. No.: 11/315,670

(22) Filed: Dec. 20, 2005

Related U.S. Application Data
(60) Provisional application No. 60/730,082, filed on Oct. 24, 2005.

(51) Int. Cl. B64C 31/06

(52) U.S. Cl. 244/154

(57) ABSTRACT

A kite is provided that includes a novel fuselage with a fore section that is closed, a top section having a top fuselage opening, and a bottom section having a bottom fuselage opening at the bottom aft of the fuselage. The configuration of the fuselage allows for the placement of payload through the top fuselage opening, and the release of the payload through the bottom fuselage opening. The payload itself may be maintained within the fuselage chamber by a releasing mechanism. The releasing mechanism is a timer mechanism to release the payload after a preset time, or alternatively, is a wireless controlled mechanism. In an alternative embodiment, the payload may be secured outside the fuselage chamber, with the releasing mechanism secured within to release the payload after a pre-set time. In another aspect, the kite itself is released using the releasing mechanism.

### PRIORITY CLAIM

The present application is a non-provisional patent application, claiming the benefit of priority of U.S. Provisional Application No. 60/730,082, filed on Oct. 24, 2005, entitled, “Kite and Release Mechanism.”

### BACKGROUND OF THE INVENTION

(1) Field of the Invention

This invention relates to kites with accessories and release mechanism and, more particularly, to kites with improved structure having a discharge mechanism for release of an accessory unit or the kite itself.

(2) Description of Related Art

Most conventional kites in the shape of an aircraft such as a plane have a fuselage that is configured to enhance flight characteristics rather than for carrying payloads. The fuselage of most prior art conventional kites maintain its shape (the interior chamber or volume) during flight by receiving air through a large opening at the front end of the fuselage, with some kites having no vent for the air flow. The air flowing through the frontal opening of the fuselage maintains its shape with a surface area that presents the greatest amount of lift for the kite when the air flows both inside and outside of the fuselage. Therefore, the fuselage of these kites mainly functions as an airfoil, which is essential for the kite's proper flight, and is not used for carrying payloads. Reference is made to the following exemplary U.S. patents that show plane-type kites with fuselage having a frontal opening: U.S. pat. Nos. 6,663,050; 6,598,833; 6,290,178; 5,076,516; 4,830,313; 4,813,637; 2,493,704; 1,864,197; 1,704,800; 1,546,099; 1,545,946; and 1,022,293, and U.S. Patent Application Publication US 2003/0192993 A1. Given the use of the fuselage as “airfoil” to generate lift or maintain its form, most of the above plane-type conventional kites cannot carry payloads nor do they have accessory units released from the fuselage.

Most conventional kite accessory release devices are associated with non-plane-types kites with no fuselage (or with no fuselage chamber) to carry a payload within. Therefore, these accessory units are supported beneath an airborne, non-plane-type kite and then subsequently dropped. Reference is made to the following exemplary U.S. patents that show non-plane-type kites with accessory release devices: U.S. Pat. Nos. 5,072,899; 4,705,239; 3,873,051; 2,936,545; 2,930,555; 2,878,615; 2,785,871; 2,680,584; 2,478,758; and 700,281. On many such prior art devices, the accessory unit is provided with a hook or a grooved wheel that can be temporarily attached to the string of an already airborne kite by the kite operator.

The hook (or wheel) of the above releasing devices typically rides up the kite's string due to the force of the same winds that support the kite. When the hook (or wheel) that is supporting the accessory device reaches a discontinuity (such as a flat plate, or an open wire frame, etc.) along the kite's string, the accessory device detaches from the string and falls to the ground. A problem of such prior devices is that the kite typically has to be airborne before the accessory device can be attached to the string. Another problem of such prior devices is that they must rely on a low altitude wind to push the accessory device up the kite's string. A further problem of such prior devices is that as soon as the accessory device reaches to a pre-determined point along the kite string it (the accessory device) becomes detached and falls. Thus, if there is a high wind the accessory device may be pushed up the kite string very quickly and subsequently be released in only a few seconds. A still further problem of such prior devices is that there is no reliable means to control the amount of time the accessory device will remain attached to the kite/kite string before it is released.

Prior art devices (e.g., U.S. Pat. No. 3,873,051) are known which comprise a time-delay release mechanism. In such prior devices the time-delay mechanism typically consists of corresponding adhesive (or VELCRO®) components that fall apart after a period of time. A problem of prior devices of this type is that it is difficult to control the amount of time before the release mechanism activates. In addition, over time, and after repeated use, the mating components do wear down, causing the length of the time delay to change. A further problem of such prior devices is that the length of the time delay is often dependent on the weight of the payload (i.e., the accessory device), and cannot be set independently. Another problem of prior devices of each of the above-mentioned types is that the accessory unit is usually loosely supported by the kite and cannot be securely attached to the kite itself prior to its (the kite's) being flown. Others (e.g., U.S. Pat. No. 5,072,899) use a liquid gel-cap as a releasing mechanism configured such that, when the gel cap is dissolved, a payload is unhook and released. However, the gel-cap cannot be re-used.

In light of the current state of the art and the drawbacks of current kites and accessory units mentioned above, a need exists for a kite that would enable a payload to be carried within its fuselage. A further need exists for a kite that would enable a payload to be coupled within the fuselage of the kite prior to the kite's flight. Still a further need exists for a kite that would allow a payload and an associated release mechanism to be carried within the fuselage, with the release mechanism having a true timer mechanism for timely release of the payload, and that the timer mechanism being reusable. Another need exists for releasing the payload using a wireless mechanism. Finally, a need exists to release the kite itself.

### BRIEF SUMMARY OF THE INVENTION

A kite is provided that includes a novel fuselage with a fore section that is closed, a top section having a top fuselage opening, and a bottom section having a bottom fuselage opening at the bottom aft of the fuselage. The configuration of the fuselage allows for the placement of payload through the top fuselage opening, and the release of the payload through the bottom fuselage opening. The payload itself may be maintained within the fuselage chamber by a releasing mechanism. In one aspect, the releasing mechanism includes a timer mechanism to release the payload after a preset time. In another aspect, the releasing mechanism is a wireless release mechanism to release the payload after receiving a wireless signal. In an alternative embodiment, the payload may be secured outside the fuselage chamber, with the releasing mechanism secured within to release the payload after a pre-set time.

One aspect of the first embodiment of the present invention provides a kite, comprising:
a fuselage;
a wing coupled with the fuselage;
a timer release mechanism coupled with the kite.

An optional aspect of the present invention provides a kite further comprising:
a payload coupled with the fuselage.

Another optional aspect of the present invention provides a kite wherein: the timer releasing mechanism is comprised of a pair of pivotally connected cooperating jaws that are in a closed position, and open after a period of time that is set by a timer of the timer releasing mechanism for releasing a payload.

Still another optional aspect of the present invention provides a kite wherein: the timer release mechanism is comprised of a bottom cap, a pair of pivotally connected cooperating jaws, a set of secondary timing gear coupled with the pair of pivotally connected cooperating jaws, a primary timing gear coupled with the secondary timing gear, a top enclosed cap coupled with the primary timing gear, and a time setting dial coupled with the bottom cap.

A further optional aspect of the present invention provides a kite wherein: the fuselage is comprised of a fore section and an aft section, including a fuselage chamber for carrying a payload;
a first lateral wall and a second lateral wall coupled with the fore and the aft sections;
a nose section that is closed and coupled with the first lateral wall and the second lateral wall;
a top coupled with first lateral wall and the second lateral wall, and integral with the nose section and a top portion of the aft section of the fuselage, the top including a top fuselage opening midway proximate the fore section of the fuselage and an air vent hole proximal the aft section of the top of the fuselage; and
a bottom coupled with the first lateral wall and the second lateral wall and integral with the fore section, having a bottom fuselage opening proximal a bottom aft section of the fuselage.

Still a further optional aspect of the present invention provides a kite wherein the fuselage is formed by a frame that is comprised of:
longitudinal spars for spreading and preventing the first lateral wall and the second lateral wall of the fuselage from vertical and longitudinal collapse; and
a fore lateral spar for spreading and preventing the first lateral wall and the second lateral wall of the fuselage from collapsing horizontally, with the fore lateral spar having a lateral spar connector for coupling the fore lateral spar with the longitudinal spars.

Yet a further optional aspect of the present invention provides a kite wherein:
the wing spars are coupled with the longitudinal spars by a sail connector body comprised of a hollow portion for receiving a longitudinal spar through the hollow portion; and
the sail connector body further including a sail connector arm for receiving the wing spars, with the wing spar having a wing spar stopper on both sides of the sail connector arm for restricting a movement of the wing spar transverse the sail connector arm;
whereby the wing is detachably connected with to the longitudinal spars of the fuselage.

Another optional aspect of the present invention provides a kite further comprising:
an adjustable molded propeller connector coupled with the fore lateral spar, and having an integral propeller connector shaft and a propeller snap cap for coupling a propeller with the fore lateral spar.

Yet another optional aspect of the present invention provides a kite wherein:
the adjustable molded propeller connector is adjusted prior to assembly of the kite, enabling the propeller connector shaft to be moved and protruded forward for coupling the propeller.

Still another optional aspect of the present invention provides a kite wherein:
the adjustable molded propeller connector has an elongated hollow portion having a first cross-section commensurate with a second cross-section of the fore lateral spar, allowing the adjustable molded propeller connector to slide longitudinally along the fore lateral spar and be fixed with a midsection thereof.

A further optional aspect of the present invention provides a kite wherein:
the first cross-section is comprised of two or more edges that are commensurate with the second cross-section, allowing the adjustable molded propeller connector to rotate transversely, about the fore lateral spar to two or more different positions.

Still a further optional aspect of the present invention provides a kite wherein:
a set of strings are coupled with the longitudinal spars for optimal flight performance and stability, and are merged at a flight line connection with a flight string connected to the flight line connection.

Another optional aspect of the present invention provides a kite wherein:
a horizontal aft wing is detachably connected with the aft section of the fuselage, with the horizontal aft wing comprised of a horizontal aft wing sail having a horizontal aft wing sail edge configured for receiving a horizontal aft wing spar for spreading the horizontal aft wing sails of the horizontal aft wing; and
one or more vertically aft wings that are detachably mounted to the aft section of the fuselage, with the one or more vertical aft wings comprised of a vertical aft wing sail having a vertical aft wing sail edge configured for receiving a vertical aft wing spar for spreading the vertical aft wing sails of the one or more vertical aft wings.

Yet another optional aspect of the present invention provides a kite wherein: the horizontal aft wing spar is comprised of a first horizontal aft wing spar and a second horizontal aft wing spar, with two ends of the first horizontal aft wing spar coupled with two ends of the second horizontal aft wing spar to form an elongated oval configuration.

Still a further optional aspect of the present invention provides a kite wherein:
the one or more vertical aft wings include a vertical aft wing merge point, where a proximal top edge of two of the one or more vertical aft wings are coupled with one another, enabling easier assembly and more stable flight.

Another optional aspect of the present invention provides a kite wherein:
an air vent hole proximal the aft section of the top of the fuselage enables air flowing through within the fuselage and moving proximal an inner top surface of the fuselage, and forcing against the aft section of the fuselage to be released, which allows flight stability by reducing lateral movement of the aft section.

Still another optional aspect of the present invention provides a kite wherein:
the payload is placed within the fuselage chamber through the top fuselage opening, and secured within the fuselage chamber by a timer releasing mechanism that is detachably coupled with a timer-release connector, which is coupled with a first edge of the top fuselage opening.

Yet another optional aspect of the present invention provides a kite wherein:
the wing is horizontally extended and detachably connected with the fuselage, with the wing comprised of a sail having a sail edge configured for receiving a wing spar for spreading the sails of the wing; and
whereby the wing is disassembled for storage and assembled for flight of the kite.

A further optional aspect of the present invention provides a kite wherein the edge of the sail is comprised of a sleeve for receiving the wing spar.

Still a further optional aspect of the present invention provides a kite wherein the kite is further comprised of a twister tail that provides continuous in flight motion for amusement, and provides flight stability by addition of a drag at an aft section of the kite for reducing lateral motions of the kite.

Another optional aspect of the present invention provides a kite wherein:
a payload is coupled with the wing of the kite by a string through a hole in a front middle section of the wing, and connected to the timer release mechanism that is housed inside the fuselage.

In another aspect, the release mechanism is a wireless release mechanism. The wireless mechanism comprises a wireless controlled releaser and a wireless controller.

The wireless controlled releaser comprises:
a housing;
a receiver connected with the housing for receiving a wireless signal from a wireless controller;
an actuator attached with the housing and electrically connected with the receiver, the actuator being capable of operating an attachment mechanism through actuation;
an attachment mechanism operably connected with the actuator, the attachment mechanism being configured to open and close upon actuation of the actuator, allowing a user to selectively connect and disconnect a payload; and
wherein the wireless controller is configured to selectively send a wireless signal for controlling the wireless controlled releaser, whereby a user may attach a payload with the attachment mechanism and fly the kite, and using the wireless controller, cause the actuator to open the attachment mechanism and thereby release the payload to float freely to the ground.

In another aspect, the attachment mechanism comprises a pair of pivotally connected cooperating jaws.

In yet another aspect, the wireless controller further includes a flight string attachment mechanism for holding a length of flight string, and wherein the flight string is connected with the wireless controlled releaser.

In another aspect, the present invention comprises a timer release mechanism for releasing a kite. The timer release mechanism comprises:
a pair of pivotally connected cooperating jaws that are settable in a closed position; and
a timer for controlling the pivotally connected cooperating jaws, where the pivotally connected cooperating jaws open after a period of time that is set by the timer for releasing a kite, whereby a user may attach a kite with the pivotally connected cooperating jaws such that when the jaws open after the period of time, the kite is released to float unrestrained to the ground.

In another aspect, the timer release mechanism further comprises:
a bottom cap;
a set of secondary timing gear coupled with the pair of pivotally connected cooperating jaws;
a primary timing gear coupled with the secondary timing gear;
a top enclosed cap coupled with the primary timing gear;
a time setting dial coupled with the bottom cap.

In another aspect, the present invention further comprises an O-ring attached with the timer release mechanism for affixing with an object.

In another aspect, the present invention comprises a wireless release mechanism for releasing a kite. In this aspect, the wireless release mechanism comprises a wireless controlled releaser and a wireless controller.

The wireless controlled releaser comprising:
a housing;
a receiver connected with the housing for receiving a wireless signal from a wireless controller;
an actuator attached with the housing and electrically connected with the receiver, the actuator being capable of operating an attachment mechanism through actuation;
an attachment mechanism operably connected with the actuator, the attachment mechanism being configured to open and close upon actuation of the actuator, allowing a user to selectively connect and disconnect a payload; and
wherein the wireless controller is configured to selectively send a wireless signal for controlling the wireless controlled releaser, whereby a user may attach a payload with the attachment mechanism and fly the kite, and using the wireless controller, cause the actuator to open the attachment mechanism and thereby release the payload to float freely to the ground.

Additionally, the attachment mechanism comprises a pair of pivotally connected cooperating jaws. The wireless controller further includes a flight string attachment mechanism for holding a length of flight string, and wherein the flight string is connected with the wireless controlled releaser.

In another aspect, the present invention relates to a releasable kite. The releasable Kite comprises:
a hand controller having a flight string;
a release mechanism attached with the flight string for connecting with a kite, the release mechanism being operable to attach and detach with the kite;
a kite for attaching with the release mechanism, whereby when the kite is attached with the release mechanism, user may fly the kite, and upon detaching from the kite, the kite floats unattached to the ground.

Additionally, the kite is a parachute-shaped kite.

Furthermore, the release mechanism is a mechanism selected from a group consisting of a timer release mechanism and a wireless release mechanism.

The wireless release mechanism further comprises a wireless controlled releaser and a wireless controller. The wireless controlled releaser further comprises:
a housing;
a receiver connected with the housing for receiving a wireless signal from a wireless controller;
an actuator attached with the housing and electrically connected with the receiver, the actuator being capable of operating an attachment mechanism through actuation;
an attachment mechanism operably connected with the actuator, the attachment mechanism being configured to open and close upon actuation of the actuator, allowing a user to selectively connect and disconnect a kite; and

wherein the hand controller is the wireless controller and is configured to selectively send a wireless signal for controlling the wireless controlled releaser, whereby a user may attach a kite with the attachment mechanism and fly the kite, and using the wireless controller, cause the actuator to open the attachment mechanism and thereby release the kite to float freely to the ground.

Additionally, the attachment mechanism comprises a pair of pivotally connected cooperating jaws.

The wireless controller further includes a flight string attachment mechanism for holding a length of flight string, and wherein the flight string is connected with the wireless controlled releaser.

In another aspect, the timer release mechanism further comprises:
a pair of pivotally connected cooperating jaws that are settable in a closed position; and
a timer for controlling the pivotally connected cooperating jaws, where the pivotally connected cooperating jaws open after a period of time that is set by the timer for releasing a kite, whereby a user may attach a kite with the pivotally connected cooperating jaws such that when the jaws open after the period of time, the kite is released to float unrestrained to the ground.

In another aspect, the timer release mechanism further comprises:
a bottom cap;
a set of secondary timing gear coupled with the pair of pivotally connected cooperating jaws;
a primary timing gear coupled with the secondary timing gear;
a top enclosed cap coupled with the primary timing gear;
a time setting dial coupled with the bottom cap.

In another aspect, the present invention further comprises an O-ring attached with the timer release mechanism for affixing with the flight string.

These and other features, aspects, and advantages of the invention will be apparent to those skilled in the art from the following detailed description of preferred non-limiting exemplary embodiments, taken together with the drawings and the claims that follow.

### BRIEF DESCRIPTION OF THE DRAWINGS

It is to be understood that the drawings are to be used for the purposes of exemplary illustration only and not as a definition of the limits of the invention. Throughout the disclosure, the word “exemplary” is used exclusively to mean “serving as an example, instance, or illustration.” Any embodiment described as “exemplary” is not necessarily to be construed as preferred or advantageous over other embodiments.

Referring to the drawings in which like reference character(s) present corresponding parts throughout:

FIG. 1 is an exemplary first perspective view illustration of one embodiment of the present invention, including a bi-wing airplane kite;

FIG. 2 is an exemplary second perspective view illustration of the bi-wing airplane kite of FIG. 1;

FIG. 3 is an exemplary enlarged view of spar connector mechanism in accordance with the present invention;

FIG. 4 is an exemplary top view illustration of the bi-wing airplane kite of FIGS. 1 and 2, in accordance with the present invention;

FIG. 5 is an exemplary bottom view illustration of the bi-wing airplane kite of FIGS. 1 and 2, in accordance with the present invention;

FIG. 6 is an exemplary enlarged illustration of the nose section of the bi-wing airplane kite of FIGS. 1 and 2 showing the details for a propeller connector, in accordance with the present invention;

FIG. 7 is an exemplary side view illustration of the bi-wing airplane kite of FIGS. 1 and 2 in accordance with the present invention;

FIG. 8 is an exemplary first perspective view illustration of one embodiment of the present invention, including a bi-wing airplane kite with payload within the fuselage;

FIG. 9 is an exemplary enlarged perspective rear view illustration of the kite illustrated in FIG. 1 and 2, showing the bottom fuselage and payload therein in accordance with the present invention;

FIG. 10 is an exemplary perspective rear view illustration of the kite illustrated in FIG. 1 and 2, showing the bottom fuselage and the release of the payload in accordance with the present invention;

FIG. 11 is an exemplary illustration of a timer release mechanism in accordance with the present invention;

FIG. 12 is an exemplary perspective view illustration of another embodiment of the present invention, including a bi-wing airplane kite with a payload;

FIG. 13 is an exemplary side view illustration of the rear or aft section of the kite of FIG. 12 in accordance with the present invention;

FIGS. 14A to 14C are exemplary schematic illustrations of coupling the payload to the kite of FIG. 12 in accordance with the present invention;

FIGS. 15A and 15B are exemplary illustrations of a wireless control mechanism, with FIG. 15A depicting a wireless controlled releaser and 15B depicting a wireless controller;

FIG. 16 is an exemplary illustration of another aspect of the present invention, depicting a releasable kite being attached with a flight string by the timer release mechanism;

FIG. 17 is an exemplary illustration of another aspect of the present invention, depicting a releasable kite being released by the timer release mechanism;

FIG. 18 is an exemplary illustration of another aspect of the present invention, depicting a releasable kite being attached with a flight string by the wireless control mechanism; and

FIG. 19 is an exemplary illustration of another aspect of the present invention, depicting a releasable kite being released by the wireless control mechanism.

### DETAILED DESCRIPTION OF THE INVENTION

The detailed description set forth below in connection with the appended drawings is intended as a description of presently-preferred embodiments of the invention and is not intended to represent the only forms in which the present invention may be constructed and or utilized. References to an airplane form are meant as illustrative of a preferred embodiment and for convenience of example. The terms airplane and fuselage that are used herein have been specifically defined below.

For the sake of convenience and clarity, this disclosure refers throughout to kites having “airplane” forms, and “airplane” is defined for the purposes of this application to mean any aircraft, real or fictional, manufactured or natural, including butterfly, “flying pigs,” etc. Further, this invention defines an aircraft as any contrivance used or designed (fictional or real) for navigation of or flight in the air or outside the atmosphere, including outer space. Where wings are unnecessary to explain the present invention, the definition includes any such aircraft, whether or not it has wings, such as dirigibles, spacecraft without wings (a non-limiting example of which is a rocket), wingless animals, and the like. The following describes one embodiment as an example only, namely an aircraft or airplane kite having one or more wings to emulate the classic propeller planes. This invention, however, contemplates kites of other designs, such as any aircraft (as defined herein), depictions of winged or un-winged animals, spacecraft, fictional crafts, cartoon, and the like.

Further, and also for the sake of convenience and clarity, this disclosure refers throughout to kites having a “fuselage.” This invention defines a fuselage as the aircraft's main body structure that includes housing or a chamber that may or may not be used for payloads or cargo and to which the wings and tails are attached. In addition, according to this invention, the fuselage also serves to position the control and stabilization surfaces in specific relationships to lifting surfaces that are required for aircraft stability and maneuverability.

The kite of the present invention includes a novel fuselage with a fore section that is closed, a top section having a top fuselage opening, and a bottom section having a bottom fuselage opening at the bottom aft of the fuselage. The present invention uses spars to form a fuselage frame, and has sails coupled with the spars that function as the skin or the walls of the fuselage to form a fuselage chamber. The configuration of the fuselage of the present invention allows for the placement of payload within the fuselage chamber through the top fuselage opening, and the release of the payload through the bottom fuselage opening. Non-limiting examples of a payload may include various action figures such as paratroopers, or multiple items like pieces of candy, etc. The payload itself may be maintained within the fuselage chamber by a releasing mechanism, which includes a timer mechanism to release the payload after a preset time. In an alternative embodiment, the payload may also be secured outside the fuselage chamber, with the releasing mechanism secured within to release the payload after a preset time.

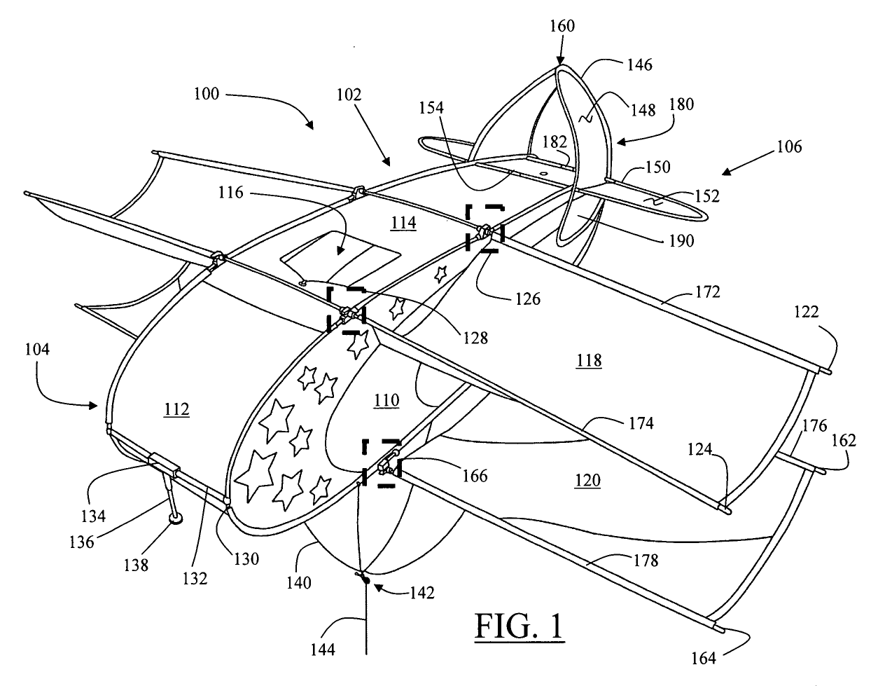

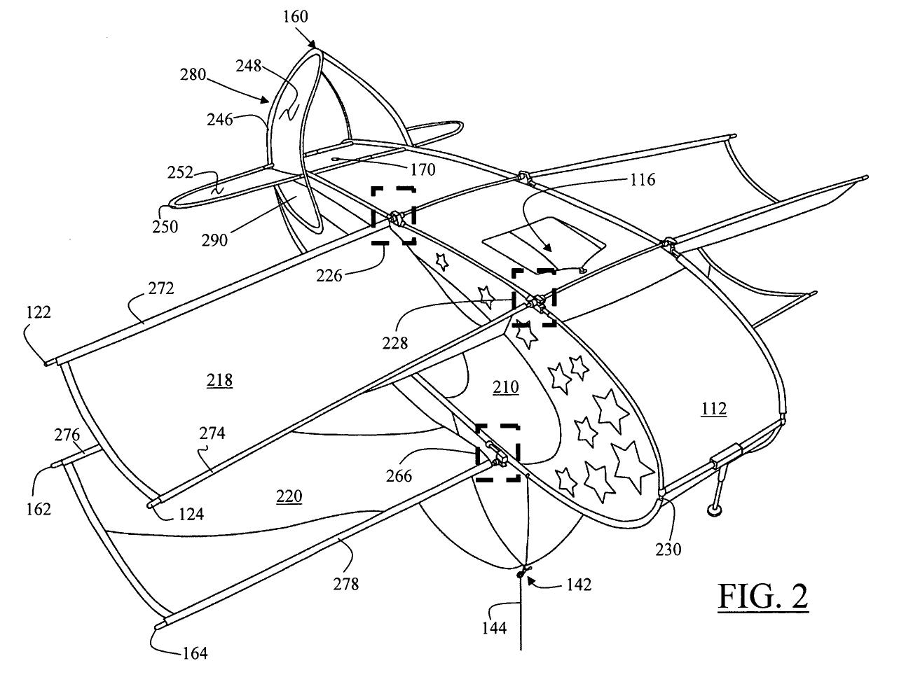

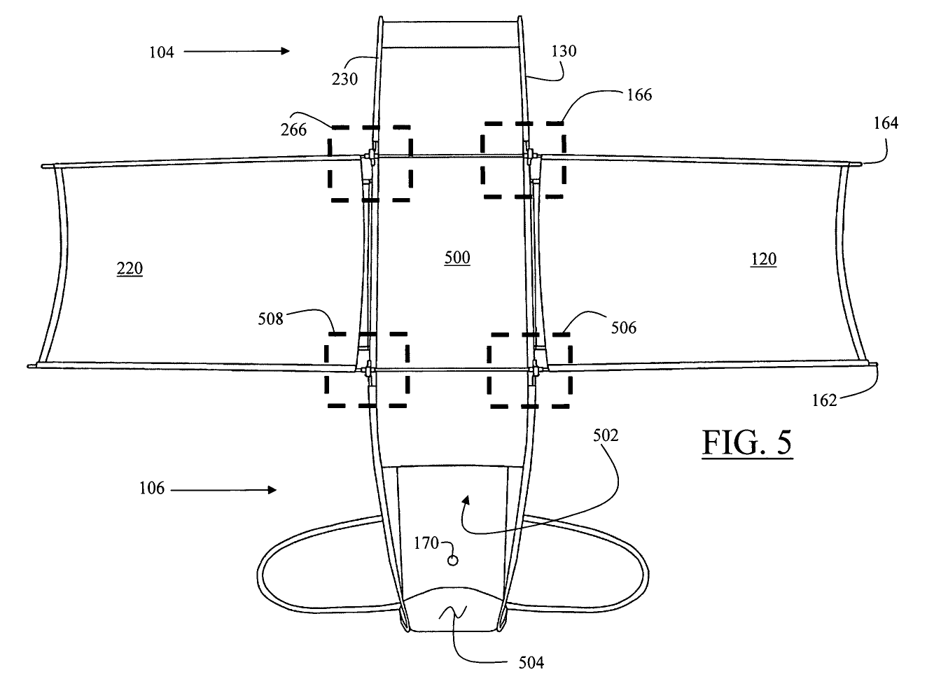

The kite 100 of a first embodiment of the present invention that is illustrated in FIGS. 1 to 11 is shown as having two wings to emulate a classic bi-wing plane. The kite 100 is comprised of a fuselage 102 having a fore section 104 and an aft section 106 for carrying a payload within the fuselage. The fuselage 102 of the kite 100 is comprised of a first lateral wall 110 and a second lateral wall 210 (FIG. 2), including a closed nose section 112 that is coupled with the first and second lateral walls 110 and 210. The fuselage 102 further includes a top 114 coupled with the two lateral walls 110 and 210. The top 114 is integral with the closed nose section 112, and includes a top fuselage opening 116 midway proximal the fore section 104 and an air vent hole 170 proximal the aft section 106 of the top 114 of the fuselage 102. The fuselage 102 further includes a bottom 500 (illustrated in FIG. 5) coupled with the two lateral wall 110 and 210, and is integral with the closed nose section 112. The bottom 500 of the fuselage 102 further includes a bottom fuselage opening 502 (illustrated in FIGS. 5, 9, and 10) proximal the aft section 106 of the fuselage 102.

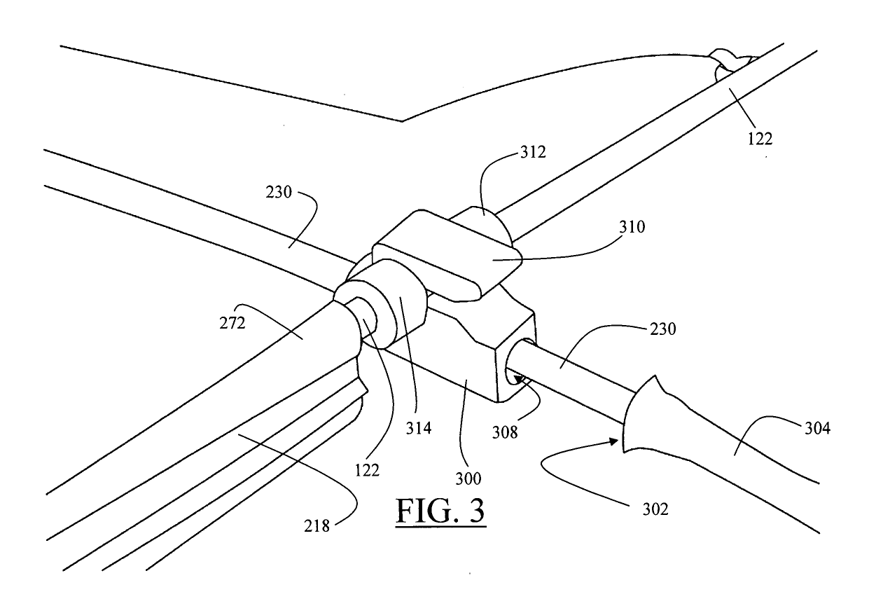

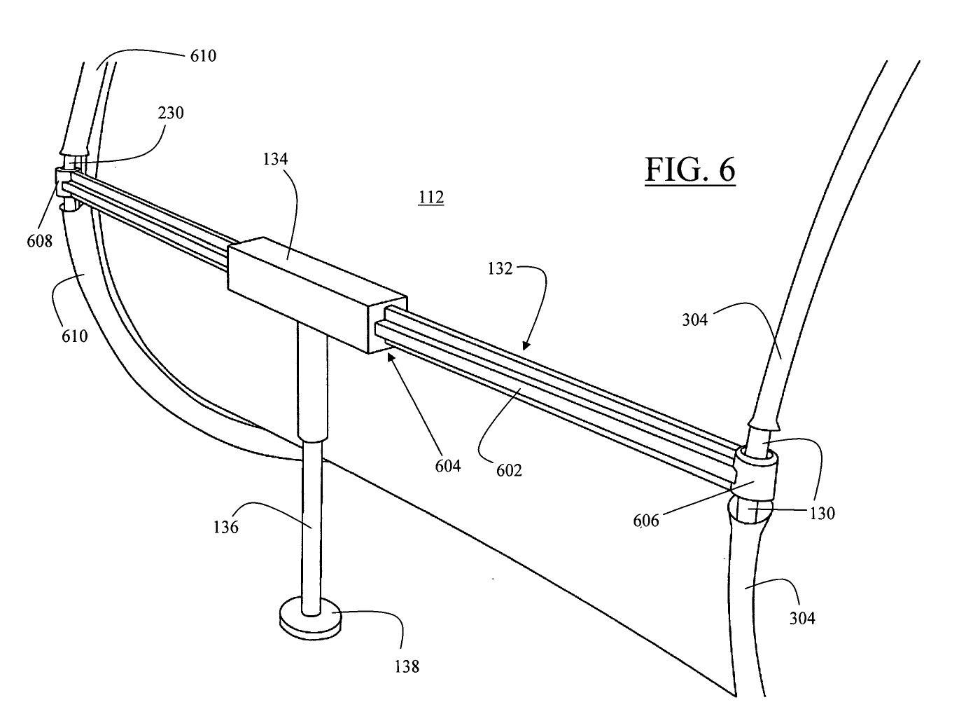

The sail or the skin of the fuselage 102 is comprised of sleeves, pockets, or other means for insertion of spars therein, which form the frame of the fuselage 102. In particular, a first longitudinal spar 130 is inserted into a first longitudinal sleeve 304 (illustrated best in FIGS. 3 and 6) and a second longitudinal spar 230 (illustrated in FIG. 2) is inserted into a second longitudinal sleeve 610 (illustrated in FIG. 6). Accordingly, the fuselage 102 is formed or put-up by a frame that is comprised of the first longitudinal spar 130 and the second longitudinal spar 230 for spreading and preventing the respective first lateral wall 10 and the second lateral wall 112 of the fuselage 102 from vertical and longitudinal collapse.

The frame of the fuselage 102 is further comprised of a fore lateral spar 132, and a pair of horizontal aft wing spars 150 and 250 (described in detail below) that also function as part of the frame of the fuselage 102. The fore lateral spar 132 and the horizontal aft wing spars 150 and 250 are used for spreading the fuselage horizontally, and preventing the first lateral wall 10 and the second lateral wall 210 of the fuselage 102 from collapsing horizontally. The fore lateral spar 132 includes a lateral spar connectors 606 and 608 (FIG. 6) for coupling the fore lateral spar 132 to the respective first longitudinal spar 130 and the second longitudinal spar 230. A set of strings 140 are coupled with the longitudinal spars 130 and 230 for optimal flight performance and stability, and are merged at a flight line connection 142 with a flight string 144 connected to the flight line connection 142 for flying the kite 100.

As further illustrated in FIGS. 1 to 11, the kite 100 of the present invention is a bi-wing plane with a pair of wings that are horizontally extended and detachably mounted to the fuselage 102. A first of the pair of wings is a top wing that is comprised of a first top sail 118 having first sail edge 172 configured for receiving a first wing spar 122 and a second sail edge 174 configured for receiving a second wing spar 124 for spreading the sails 118 of the top wing. The top wing is further comprised of a second top sail 218 (FIG. 2) having a third sail edge 272 configured for receiving the first wing spar 122 and a fourth sail edge 274 configured for receiving the second wing spar 124 for spreading the second top sail 218 of the top wing. All the sail edges 172, 174, 272, and 274 constitute the sleeves of the sails for insertion of the first and second wing spars 122 and 124.

As illustrated, a second of the pair wings is a bottom wing that is comprised of a first bottom sail 120 having fifth sail edge 176 configured for receiving a third wing spar 162 and a sixth sail edge 178 configured for receiving a fourth wing spar 164 for spreading the sails 120 of the bottom wing. The bottom wing is further comprised of a second bottom sail 220 (FIG. 2) having a seventh sail edge 276 configured for receiving the third wing spar 162 and an eighth sail edge 278 configured for receiving the fourth wing spar 164 for spreading the second bottom sail 220 of the bottom wing. All the sail edges 176, 178, 276, and 278 constitute the sleeves of the sails for insertion of the third and fourth wing spars 162 and 164.

The wing spars are detachably coupled with the longitudinal spars by a respective set of spar connectors, which is illustratively enlarged and referenced as element 300 in FIG. 3. The spar connectors are comprised of a hollow portion 308 for receiving and passing through a longitudinal spar, and further include a sail connector arm 310 for receiving a wing spar, with the wing spar having a wing spar stoppers 314 and 312 configured on either side of the sail connector arm 310 for restricting a movement of the wing spar transverse the sail connector arm 310. Accordingly, the wings of the kite 100 are detachably mounted to the longitudinal spars of the fuselage 102.

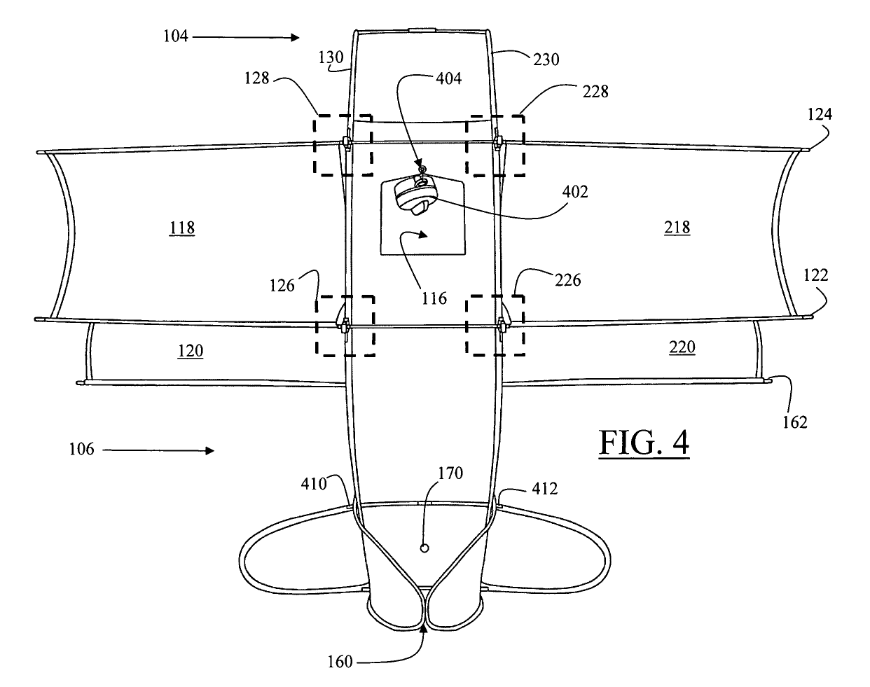

More specifically (and as best illustrated in FIG. 4), the first wing spar 122 is detachably coupled with the first and the second longitudinal spars 130 and 230 by a respective set of first and second spar connectors 126 and 226, and the second wing spar 124 is detachably coupled with the first and the second longitudinal spars 130 and 230 by a respective set of third and fourth spar connectors 128 and 228. The third wing spar 162 is detachably coupled with the first and the second longitudinal spars 130 and 230 by a respective set of fifth and sixth spar connectors 506 and 508 (illustrated in FIG. 5), and the fourth wing spar 164 is detachably coupled with the first and the second longitudinal spars 130 and 230 by a respective set of seventh and eighth spar connectors 166 and 266.

As further illustrated in FIGS. 1 to 11, the aft section 106 of the kite 100 of the present invention is further comprised of a horizontal aft wing that is detachably mounted to the aft section 106 of the fuselage 102. The horizontal aft wing is comprised of a first horizontal aft wing sail 152 and a second horizontal aft wing sail 252 having respective first and second horizontal aft wing sail edges 150 and 250 configured for receiving a respective first and second horizontal aft wing spars 410 and 412 (FIG. 4) for spreading the respective first horizontal aft wing sails 152 and 252. The two ends of the first horizontal aft wing spar 410 and the two ends of the second horizontal aft wing spar 412 are coupled together by couplers 154 and 182 to form an elongated oval configuration horizontal aft wing. The couplers 154 and 182 may be comprised of metal ferrules.

The aft section 106 further includes a first vertical aft wing 180 and a second vertical aft wing 280 that are connected with the aft section 106 of the fuselage 102. The first and second vertical aft wings 180 and 280 are comprised of first and second vertical aft wing sails 148 and 284 that have respective first and second vertical aft wing sail edge 146 and 246 configured for receiving first and second vertical aft wing spars for spreading the respective first and second vertical aft wing sails 148 and 248. The first vertical aft wing 180 and the second vertical aft wing 280 include a vertical aft wing merge point 160, where a proximal top edge of the both vertical aft wings 180 and 280 are coupled with one another, enabling for easier assembly and better flight stability. A first lower section 190 of the first vertical aft wing 180 is mounted onto the first lateral wall 110, proximal the aft section 106 of the fuselage 102. A second lower section 290 of the second vertical aft wing 280 is mounted onto the second lateral wall 210, proximal the aft section 106 of the fuselage 102. When disassembled, the kite aft section 106 fully collapses horizontally, allowing the first vertical aft wing 180 to move towards the second vertical aft wing 280. When fully assembled, due, in part, to the fore lateral spar 132 and the horizontal aft wing, the fuselage 102 of the kite 100 expands horizontally, stretching the lower portions 190 and 290 of the respective two vertical aft wings 180 and 280 away from each other.

The fuselage 102 of the kite 100 further includes an air vent hole 170 proximal the aft section 106 of the top 114 of the fuselage 102. The air vent hole 170 enables the releasing of the air flowing through within the fuselage 102. That is, the air first moves inside the fuselage 102 through the top fuselage opening 116 and continues proximal an inner top surface of the fuselage, and then flows against a partial enclosure 504 (best illustrated in FIGS. 5, 9, and 10) of the aft section 106 of the fuselage 102. This creates an unstable flight condition that generates rapid and uncontrolled lateral movement of the aft section 106 of the kite 100. The air vent hole 170 allows the air moving inside the fuselage 102 to be released, providing flight stability.

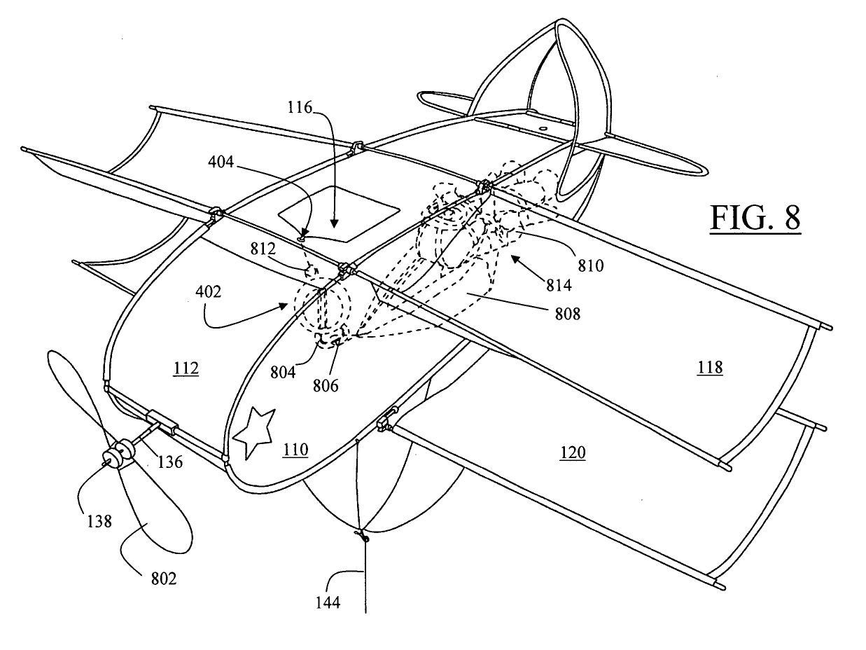

FIG. 6 is an enlarged illustration of the fore lateral spar 132, illustrating the details of an adjustable molded propeller connector 134 that has an integral propeller connector shaft 136, and a propeller snap cap 138 for coupling a propeller 802 (illustrated in FIG. 8) to the fore lateral spar 132. The adjustable molded propeller connector 134 is adjusted prior to assembly of the kite 100, enabling the propeller connector shaft 136 to be moved and protruded forward for coupling the propeller 802, as illustrated in FIG. 8. The adjustable molded propeller connector 134 includes an elongated hollow portion 404 having a cross-section commensurate with a cross-section 602 of the fore lateral spar 132, allowing the adjustable molded propeller connector 134 to slide longitudinally along the fore lateral spar 132 and be fixed to a midsection thereof. The connector 134 cross-section is comprised of two or more edges that are commensurate with the cross-section 602, allowing the adjustable molded propeller connector 134 to rotate transversely, about the fore lateral spar 132 to two or more different positions.

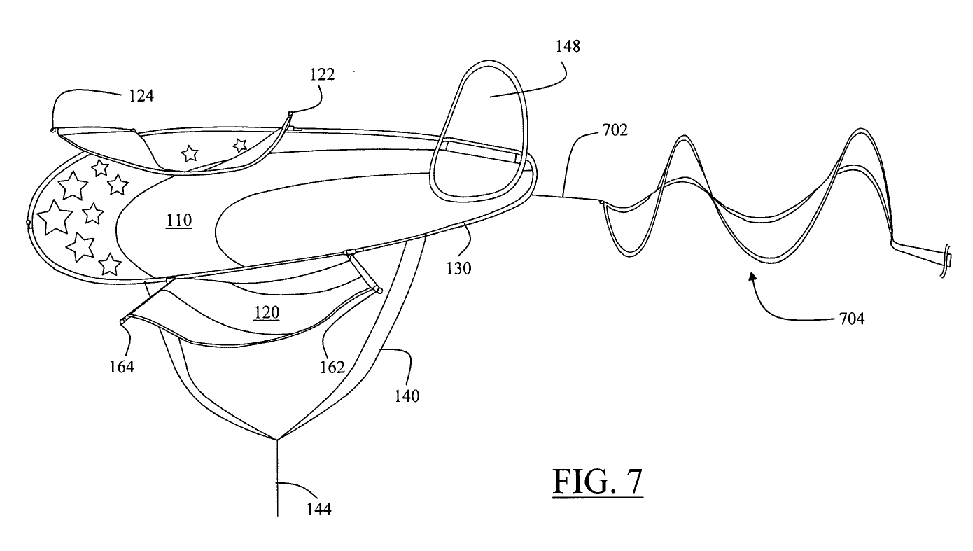

As best illustrated in FIG. 7, the kite 100 is further comprised of a twister tail 704 that provides continuous motion for amusement, and provides flight stability by addition of a drag at the aft section 106 of the kite 100 for reducing lateral motions of the kite 100. The twister tail 704 is coupled with the aft section 106 through a string 702. FIGS. 8 to 10 illustrated the fuselage 102 of kite 100 carrying a payload. The payload may comprised of a releasing mechanism 402 (such as a timer releasing mechanism) of the present invention that is detachably coupled with a timer-release connector 404 on a first edge of the top fuselage opening 116 by a string through an O-ring 812 (or other similar connecting mechanism) of the timer release mechanism 402. As can be appreciated by one skilled in the art, the O-ring 812 is not intended to be limited to a circular shape but be formed in any suitable shape to allow a string or other device to be connected with it. Thus, the term O-ring 812 is used for convenience purposes only and does not necessarily imply a circular shape. The payload may further include an accessory unit 514 (best illustrated in FIGS. 8 to 10) that is coupled with the timer releasing mechanism 402. As illustrated, the accessory unit 814 may comprise of a paratrooper 810 wearing a parachute 808 that is securely coupled with a pair of cooperative jaws 804 and 806 of the timer release mechanism 402 by a payload string. The pair of cooperative jaws 804 and 806 of the timer releasing mechanism 402 are pivotally connected, and are initially in a closed position, and open after a period of time that is set by a user of the timer releasing mechanism 402 to release a payload coupled with the cooperative jaws 804 and 806 by the payload string loop.

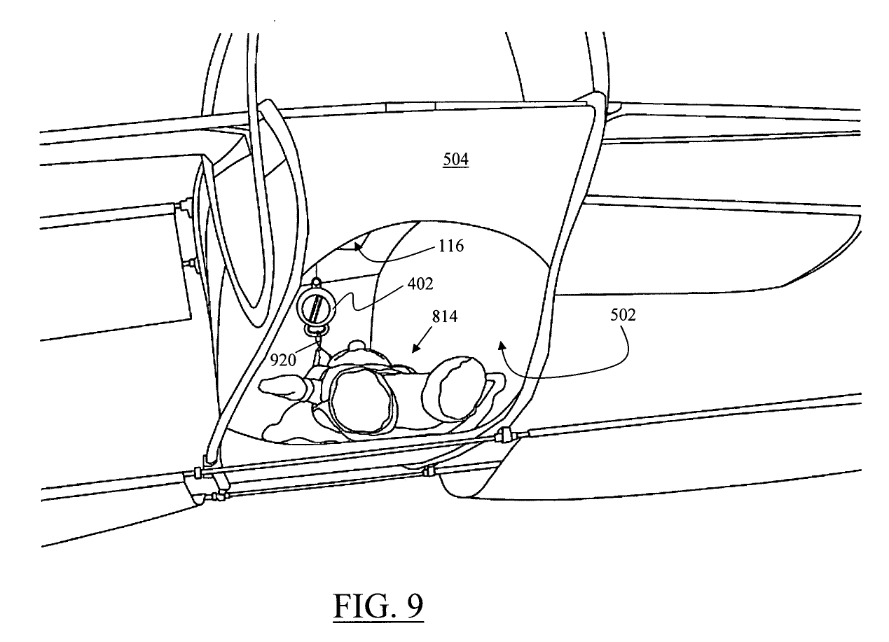

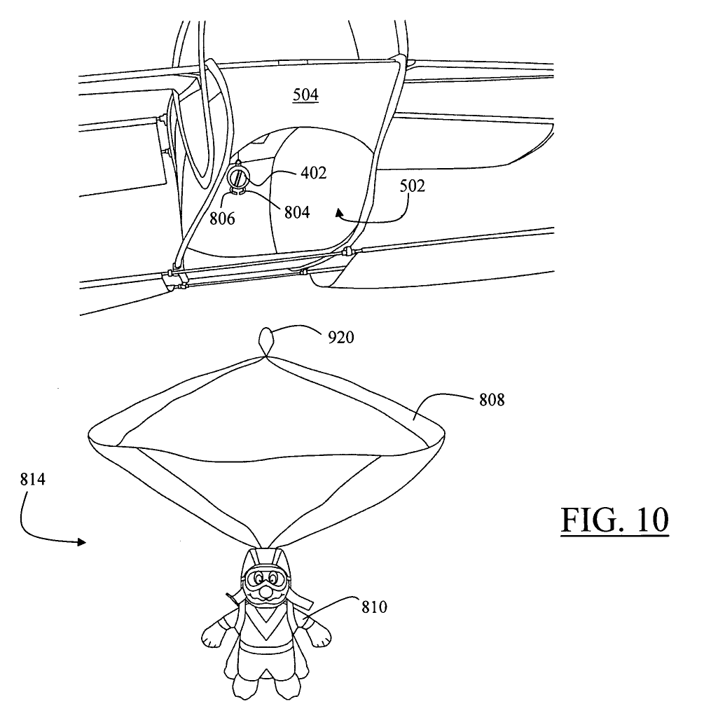

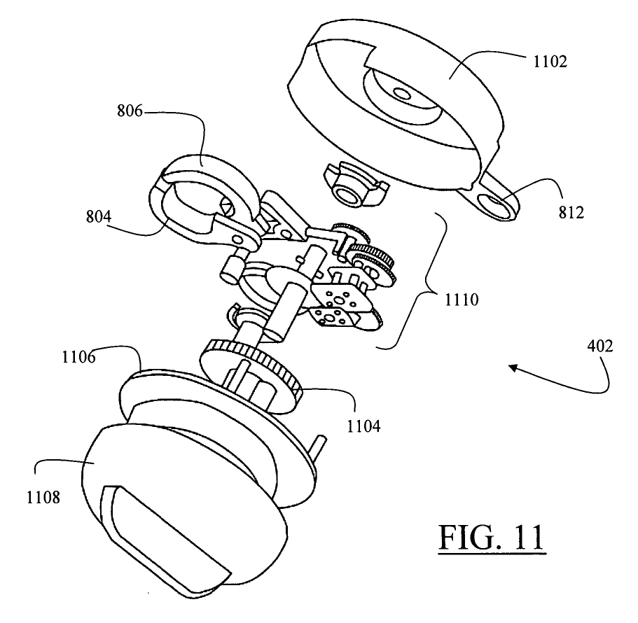

FIGS. 9 and 10 illustrate the details of the payload securely placed within the fuselage 102 (FIG. 9), and released through the bottom fuselage opening 502 (FIG. 11). As illustrated in FIG. 9, the fuselage 102 includes sufficient space or volume to carry a timer release mechanism 402 and a payload 814, and includes a bottom fuselage opening 502 for the discharge of the payload 814 after a preset time. The cooperative jaws 804 and 806 of the timer release mechanism 402 are inserted and closed together in a payload O-ring 920 to securely maintain the payload 814 within the fuselage 102 during flight. Prior to the flight of the kite 100, a user may secure the payload 814 to the timer release mechanism 402 and set the timer for a preset time to open the jaws 804 and 806 of the timer release mechanism 402 to release the payload 814 at that preset time during the flight. As illustrated in FIG. 10, when the preset time expires, the jaws 804 and 806 of the timer release mechanism 402 open to allow the payload O-ring 920 to be released, and the payload 814 to be discharged from the bottom fuselage opening 502. Upon discharge, the parachute 808 of the payload 814 (in this case a paratrooper 810) opens, allowing for a realistic descention of the payload 814.

As best illustrated in FIG. 11, the timer release mechanism 402 is comprised of a bottom cap 1102 with an O-ring 812 to allow users to hang or detachably couple the timer release mechanism with a first edge of the top fuselage opening 116 by some string. Timer release mechanism 402 further includes the pair of pivotally connected cooperating jaws 804 and 806 that are normally in a closed position to secure a string loop 920 of a payload 814 thereto, a set of secondary timing gear 1110, a primary timing gear 1104, a top enclosed cap 1106, and a time setting dial 1108. The timer release mechanism 402 functions similar to an “egg timer.” However, instead of sounding a bell, it opens the cooperating jaws 804 and 806 at a preset time.

In addition to using the timer release mechanism 402 to release the payload, the timer release mechanism 402 can be connected between the flight string 144 and a kite itself, such that upon opening, the kite is released from the flight string 144 to float freely to the ground.

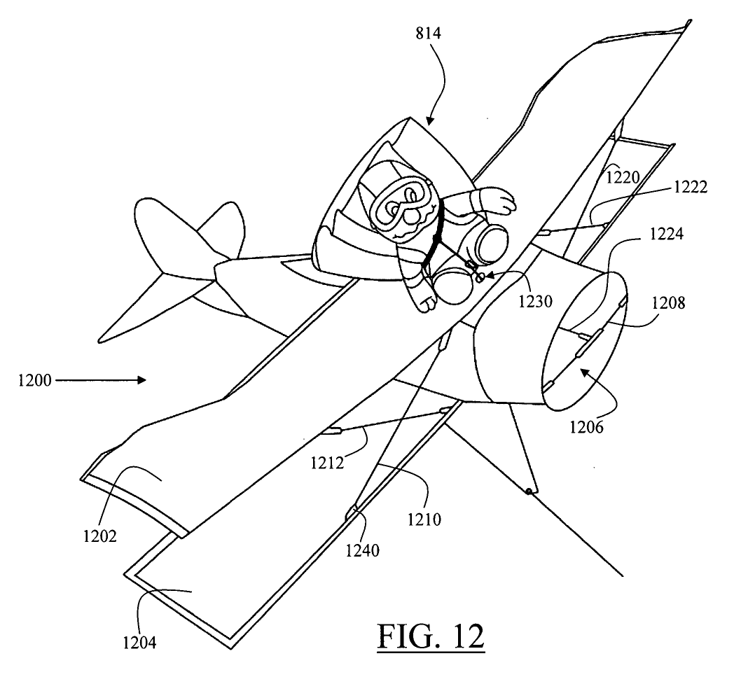

FIG. 12 illustrates the use of the payload 814 and a timer release mechanism 402 of the present invention with an alternative plane kite 1200 in accordance with the present invention. The kite 1200 is a bi-wing type plane, with a top wing 1202 and bottom wing 1204 that are supported by a first wing spar 1210, a second wing spar 1212, a third wing spar 1220, and a fourth wing spar 1222. The ends of the wing spars are inserted on the front edges of the airplane's wings into the corresponding wing spar connectors 1240 on the bottom wing 1204, creating two X's. The top wing 1202 of the kite 1200 of the present invention includes a hole 1230 to allow the payload 814 to be coupled with the kite 1200. The fuselage 1206 of the kite 1200 is formed by a fore horizontal spar 1208, which forms a “T” with a connected longitudinal spar 1224.

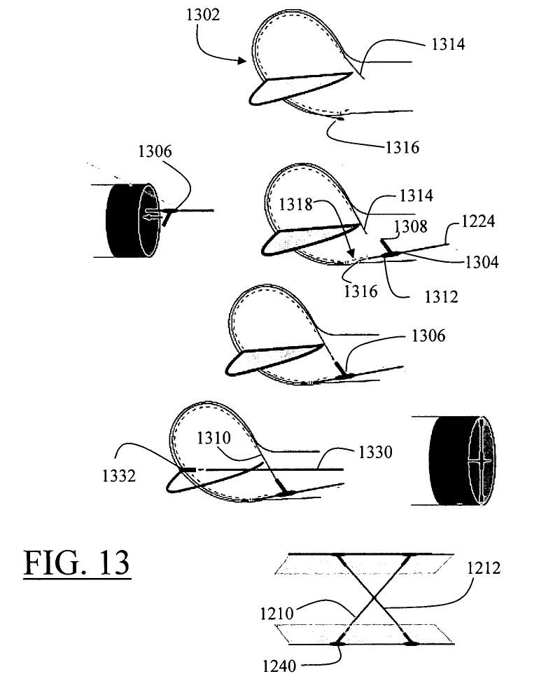

As best illustrated in FIG. 13, the longitudinal spar 1224 extends to an aft section 1302 of the kite 1200, and is connected to a first end 1304 of a molded connector 1306, with a second end 1308 of the molded connector 1306 connected to a first end 1314 of a tail fin spar 1310, and a third end 1312 of the molded connector 1306 coupled with second end 1316 of the tail fin spar 1310, located inside a tail fin pocket 1318, near the bottom aft section 1302 of the kite 1200. Accordingly, the tail fin spar 1310, the longitudinal spar 1224, and the fore horizontal spar 1208 form the fuselage 1206 for the kite 1200. The kite 1200 also includes a propeller spar 1330 placed longitudinally within the fuselage, and connected to an aft section connector 1332, enabling a connection of a propeller 802 to the front end of the fuselage 1206.

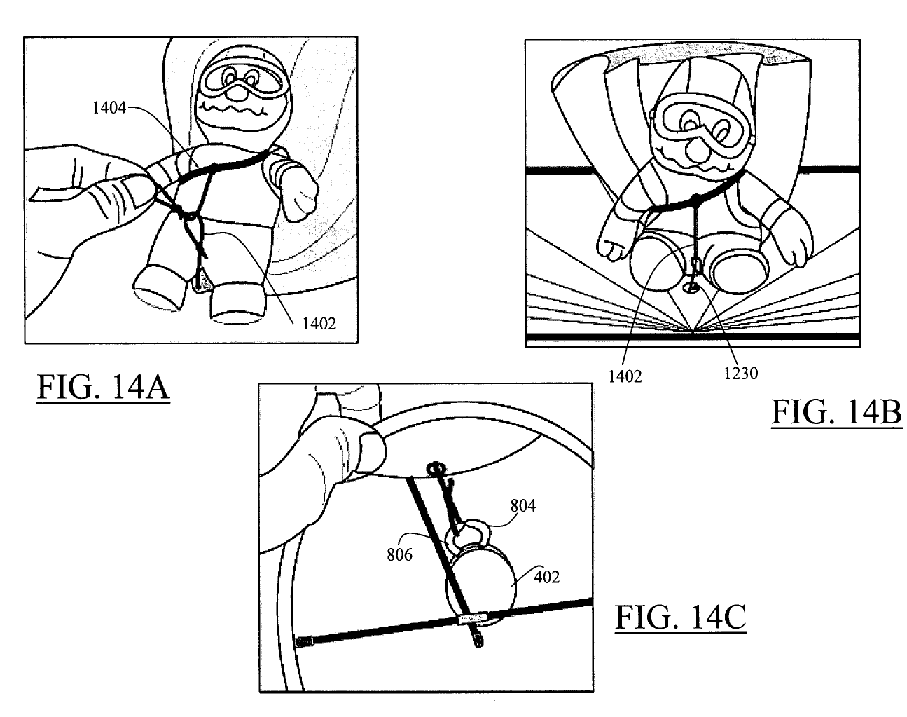

As best illustrated in FIGS. 14A to 14C, in this embodiment, the payload 814 may be coupled with the top wing 1202 of the kite 1200 by a body string 1404 to a timer mechanism string 1402, as illustrated in FIG. 14A. The string 1402 is inserted through the hole 1230 on the top wing 1202. The payload 814 (in this case the paratrooper 810) sits on top of part of the parachute 808, as illustrated in FIG. 14B. The string 1402 is then coupled with the cooperating jaws 804 and 806 of the timer release mechanism 402, with the timer 402 coupled with a top wing spar 140 as illustrated in FIG. 14C. The user may then turn the time setting dial 1108 prior to flight.

In addition to the timer release mechanism 402 described above, the release mechanism can be a wireless release mechanism. In such an aspect, the timer release mechanism 402 can be replaced with the wireless release mechanism to allow a user to selectively release the payload 814 using the wireless release mechanism.

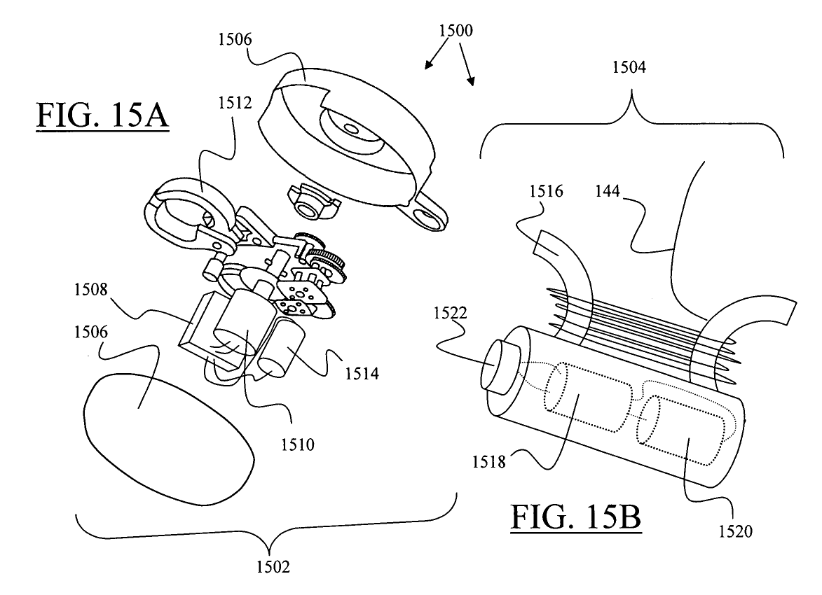

FIGS. 15A and 15B illustrate a wireless release mechanism 1500 according to the present invention. The wireless release mechanism 1500 includes two distinct parts, a wireless controlled releaser 1502 (as depicted in FIG. 15A) and a wireless controller 1504 (as depicted in FIG. 15B).

The wireless controlled releaser 1502 is any suitable mechanism or device capable of receiving a wireless signal to selectively attach and/or detach an airborne object (e.g., payload and kite). The wireless controlled releaser 1502 includes a housing 1506 with a receiver 1508 encased within the housing 1506 for receiving a wireless signal from the wireless controller 1504. An actuator 1510 is encased within the housing 1506 and electrically connected with the receiver 1508. An attachment mechanism 1512 is operably connected with the actuator 1510. The attachment mechanism 1512 is configured to open and close to allow a user to selectively connect and disconnect with the object. The actuator 1510 is any suitable mechanism or device that upon receiving a signal from the receiving 1508, is capable of actuating to cause the attachment mechanism 1512 to open and/or close. As a non-limiting example, the actuator 1510 is a motor or servo. Additionally, the attachment mechanism 1512 is any suitable mechanism or device that is operable for attaching and detaching with an object upon actuation of the actuator 1510. As a non-limiting example, the attachment mechanism 1512 is a pair of pivotally connected cooperating jaws. A power source 1514 is included in the wireless controlled releaser 1502 for powering the actuator 1510.

The wireless controller 1504 is configured to selectively send a wireless signal for controlling the wireless controlled releaser 1502. The wireless controller 1504 also includes a flight string attachment mechanism 1516 for holding a length of flight string 144 for connecting with the kite. Additionally, a transmitter 1518 and a power source 1520 are encased within the wireless controller 1504. A button 1522 or other similar device is attached with the wireless controller 1504 for causing the transmitter 1518 to send the signal to the wireless controlled releaser 1502.

Using the wireless release mechanism 1500, a user may attach a payload with the attachment mechanism 1512 and fly the kite. Using the wireless controller 1504, the user can selectively actuate the actuator 1510 to open the attachment mechanism 1512 and thereby release the payload to float freely to the ground.

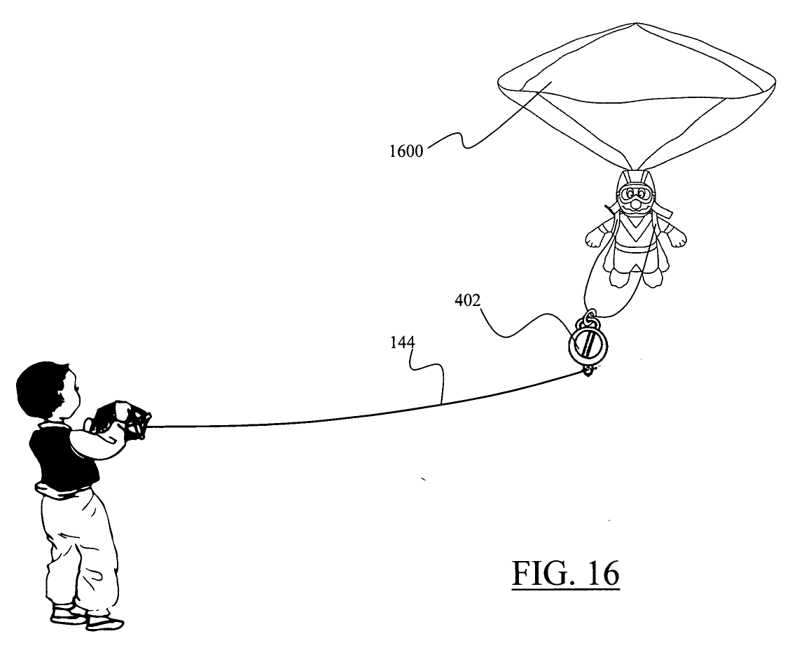

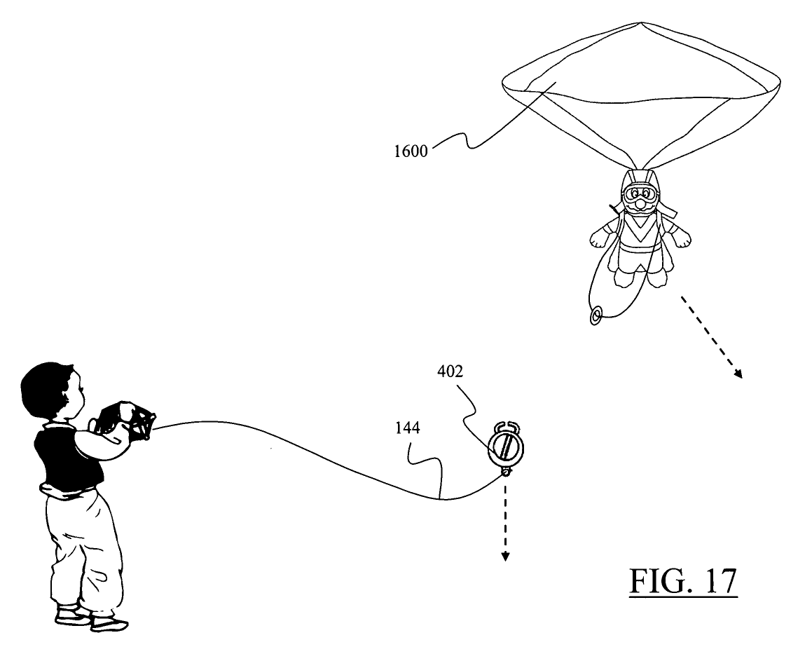

As briefly described above and as shown in FIGS. 16 and 17, the timer release mechanism 402 can also be used to release a kite 1600. In this aspect, the timer release mechanism 402 is attached between the flight string 144 and the kite 1600. Upon reaching the determined amount of time, the timer release mechanism 402 opens to release the kite 1600 and fall to the ground. After being released, the kite 1600 is unattached is as free to float to the ground. As can be appreciated by one skilled in the art, the kite 1600 can be formed in a variety of shapes. However, it is desirable to have the kite 1600 be parachute-shaped so that upon release, it slowly descends to the ground.

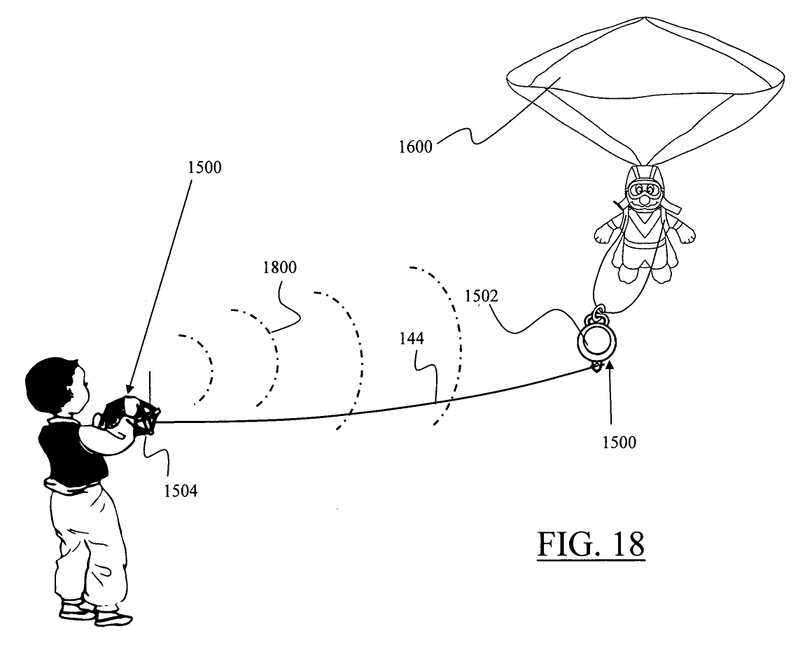

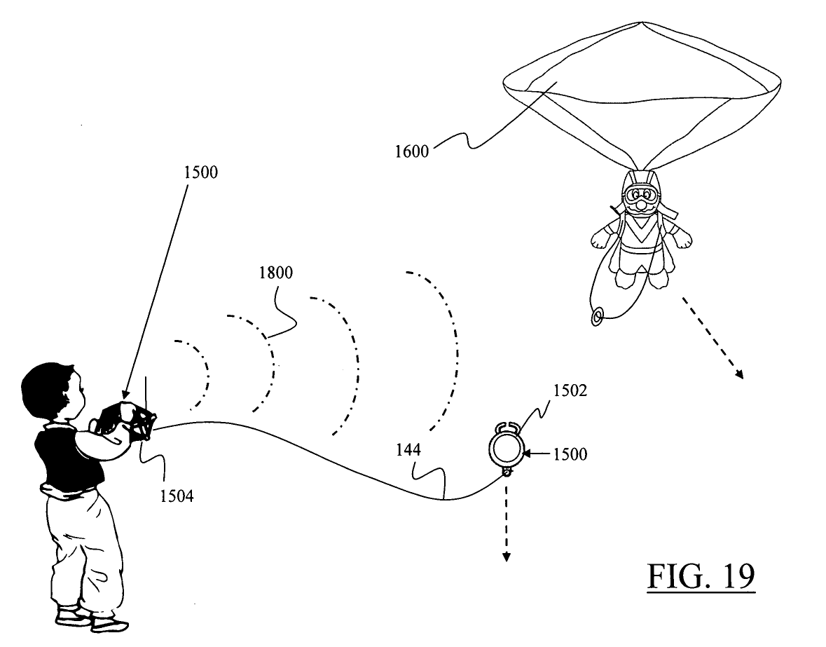

Similar to the timer release mechanism 402, as shown in FIGS. 18 and 19, the wireless release mechanism 1500 can be used to release a kite 1600. In this aspect, the wireless controller 1504 includes flight string 144 that is connected with the wireless controlled releaser 1502, while the wireless controlled releaser 1502 is connected with the kite. Using the wireless controller 1502, a user can send a wireless signal 1800 that is received by the wireless controlled releaser 1502. Upon receipt of the signal 1800, the wireless controlled releaser 1502 releases the kite 1600 and falls to the ground. Upon release, the kite 1600 thereafter is free to float to the ground. In the aspects depicted in FIGS. 16 through 19, the kite 1600 is a releasable kite that can be flown by a user until released.

Although the invention has been described in considerable detail in language specific to structural features and/or method acts, it is to be understood that the invention defined in the appended claims is not necessarily limited to the specific features or acts described. Rather, the specific features and acts are disclosed as preferred forms of implementing the claimed invention. Therefore, while exemplary illustrative embodiments of the invention have been described, numerous variations and alternative embodiments will occur to those skilled in the art. For example, any non-plane-type kites may be used to couple any type of a load to a timer release mechanism. Such variations and alternate embodiments are contemplated, and can be made without departing from the spirit and scope of the invention.

What is claimed is:

1. A kite, comprising:
a fuselage;
a wing coupled with the fuselage;
a release mechanism coupled with the kite.

2. The kite as set forth in claim 1, further comprising:
a payload coupled with the fuselage.

3. The kite as set forth in claim 1, wherein the release mechanism is a timer release mechanism, comprised of a pair of pivotally connected cooperating jaws that are settable in a closed position, such that they open after a period of time that is set by a timer of the timer release mechanism for releasing a payload.

4. The kite as set forth in claim 1, wherein the release mechanism is a time release mechanism, comprised of a bottom cap, a pair of pivotally connected cooperating jaws, a set of secondary timing gear coupled with the pair of pivotally connected cooperating jaws, a primary timing gear coupled with the secondary timing gear, a top enclosed cap coupled with the primary timing gear, and a time setting dial coupled with the bottom cap.

5. The kite as set forth in claim 1, wherein the fuselage is comprised of:
a fore section and an aft section, including a fuselage chamber for carrying a payload;
a first lateral wall and a second lateral wall coupled with the fore and the aft sections;
a nose section that is closed and coupled with the first lateral wall and the second lateral wall;
a top coupled with first lateral wall and the second lateral wall, and integral with the nose section and a top portion of the aft section of the fuselage, the top including a top fuselage opening midway proximate the fore section of the fuselage and an air vent hole proximal the aft section of the top of the fuselage; and
a bottom coupled with the first lateral wall and the second lateral wall and integral with the fore section, having a bottom fuselage opening proximal a bottom aft section of the fuselage.

6. The kite as set forth in claim 5, wherein the fuselage is formed by a frame that is comprised of:
longitudinal spars for spreading and preventing the first lateral wall and the second lateral wall of the fuselage from vertical and longitudinal collapse; and
a fore lateral spar for spreading and preventing the first lateral wall and the second lateral wall of the fuselage from collapsing horizontally, with the fore lateral spar having a lateral spar connector for coupling the fore lateral spar with the longitudinal spars.

7. The kite as set forth in claim 6, wherein:
the wing spars are coupled with the longitudinal spars by a sail connector body comprised of a hollow portion for receiving a longitudinal spar through the hollow portion; and
the sail connector body further including a sail connector arm for receiving the wing spars, with the wing spar having a wing spar stopper on both sides of the sail connector arm for restricting a movement of the wing spar transverse the sail connector arm;
whereby the wing is detachably connected with to the longitudinal spars of the fuselage.

8. The kite as set forth in claim 6, further comprising:
an adjustable molded propeller connector coupled with the fore lateral spar, and having an integral propeller connector shaft and a propeller snap cap for coupling a propeller with the fore lateral spar.

9. The kite as set forth in claim 8, wherein:
the adjustable molded propeller connector is adjusted prior to assembly of the kite, enabling the propeller connector shaft to be moved and protruded forward for coupling the propeller.

10. The kite as set forth in claim 8, wherein:
the adjustable molded propeller connector has an elongated hollow portion having a first cross-section commensurate with a second cross-section of the fore lateral spar, allowing the adjustable molded propeller connector to slide longitudinally along the fore lateral spar and be fixed with a midsection thereof.

11. The kite as set forth in claim 10, wherein:
the first cross-section is comprised of two or more edges that are commensurate with the second cross-section, allowing the adjustable molded propeller connector to rotate transversely, about the fore lateral spar to two or more different positions.

12. The kite as set forth in claim 6, wherein:
a set of strings are coupled with the longitudinal spars for optimal flight performance and stability, and are merged at a flight line connection with a flight string connected to the flight line connection.

13. The kite as set forth in claim 5, wherein:
a horizontal aft wing is detachably connected with the aft section of the fuselage, with the horizontal aft wing comprised of a horizontal aft wing sail having a horizontal aft wing sail edge configured for receiving a horizontal aft wing spar for spreading the horizontal aft wing sails of the horizontal aft wing; and
one or more vertically aft wings that are detachably mounted to the aft section of the fuselage, with the one or more vertical aft wings comprised of a vertical aft wing sail having a vertical aft wing sail edge configured for receiving a vertical aft wing spar for spreading the vertical aft wing sails of the one or more vertical aft wings.

14. The kite as set forth in claim 13, wherein:
the horizontal aft wing spar is comprised of a first horizontal aft wing spar and a second horizontal aft wing spar, with two ends of the first horizontal aft wing spar coupled with two ends of the second horizontal aft wing spar to form an elongated oval configuration.

15. The kite as set forth in claim 13, wherein:
the one or more vertical aft wings include a vertical aft wing merge point, where a proximal top edge of two of the one or more vertical aft wings are coupled with one another, enabling easier assembly and more stable flight.

16. The kite as set forth in claim 5, wherein:
an air vent hole proximal the aft section of the top of the fuselage enables air flowing through within the fuselage and moving proximal an inner top surface of the fuselage, and forcing against the aft section of the fuselage to be released, which allows flight stability by reducing lateral movement of the aft section.

17. The kite as set forth in claim 5, wherein the release mechanism is a timer release mechanism and wherein:
the payload is placed within the fuselage chamber through the top fuselage opening, and secured within the fuselage chamber by a timer release mechanism that is detachably coupled with a timer-release connector, which is coupled with a first edge of the top fuselage opening.

18. The kite as set forth in claim 1, wherein:
the wing is horizontally extended and detachably connected with the fuselage, with the wing comprised of a sail having a sail edge configured for receiving a wing spar for spreading the sails of the wing; and
whereby the wing is disassembled for storage and assembled for flight of the kite.

19. The kite as set forth in claim 6, wherein:
the edge of the sail is comprised of a sleeve for receiving the wing spar.

20. The kite as set forth in claim 1, wherein:
the kite is further comprised of a twister tail that provides continuous in flight motion for amusement, and provides flight stability by addition of a drag at an aft section of the kite for reducing lateral motions of the kite.

21. The kite as set forth in claim 1, wherein:
a payload is coupled with the wing of the kite by a string through a hole in a front middle section of the wing, and connected to the timer release mechanism that is housed inside the fuselage.

22. The kite as set forth in claim 1, wherein the release mechanism is a wireless release mechanism comprising a wireless controlled releaser and a wireless controller, wherein:
the wireless controlled releaser comprises:
a housing;
a receiver connected with the housing for receiving a wireless signal from a wireless controller;
an actuator attached with the housing and electrically connected with the receiver, the actuator being capable of operating an attachment mechanism through actuation;
an attachment mechanism operably connected with the actuator, the attachment mechanism being configured to open and close upon actuation of the actuator, allowing a user to selectively connect and disconnect a payload; and
wherein the wireless controller is configured to selectively send a wireless signal for controlling the wireless controlled releaser, whereby a user may attach a payload with the attachment mechanism and fly the kite, and using the wireless controller, cause the actuator to open the attachment mechanism and thereby release the payload to float freely to the ground.

23. The kite as set forth in claim 22, wherein the attachment mechanism comprises a pair of pivotally connected cooperating jaws.

24. The kite as set forth in claim 23, wherein the wireless controller further includes a flight string attachment mechanism for holding a length of flight string.

25. A timer release mechanism for releasing a kite, comprising:
a pair of pivotally connected cooperating jaws that are settable in a closed position; and
a timer for controlling the pivotally connected cooperating jaws, where the pivotally connected cooperating jaws open after a period of time that is set by the timer for releasing a kite, whereby a user may attach a kite with the pivotally connected cooperating jaws such that when the jaws open after the period of time, the kite is released to float unrestrained to the ground.

26. A timer release mechanism as set forth in claim 25, further comprising:
a bottom cap;
a set of secondary timing gear coupled with the pair of pivotally connected cooperating jaws;
a primary timing gear coupled with the secondary timing gear;
a top enclosed cap coupled with the primary timing gear;
a time setting dial coupled with the bottom cap.

27. A timer release mechanism as set forth in claim 26, further comprising an O-ring attached with the timer release mechanism for affixing with an object.

28. A wireless release mechanism for releasing a kite, comprising a wireless controlled releaser and a wireless controller, wherein:
the wireless controlled releaser comprises:
a housing;
a receiver connected with the housing for receiving a wireless signal from a wireless controller;
an actuator attached with the housing and electrically connected with the receiver, the actuator being capable of operating an attachment mechanism through actuation;
an attachment mechanism operably connected with the actuator, the attachment mechanism being configured to open and close upon actuation of the actuator, allowing a user to selectively connect and disconnect a payload; and
and wherein the wireless controller is configured to selectively send a wireless signal for controlling the wireless controlled releaser, whereby a user may attach a payload with the attachment mechanism and fly the kite, and using the wireless controller, cause the actuator to open the attachment mechanism and thereby release the payload to float freely to the ground.

29. A wireless release mechanism as set forth in claim 28, wherein the attachment mechanism comprises a pair of pivotally connected cooperating jaws.

30. A wireless release mechanism as set forth in claim 29, wherein the wireless controller further includes a flight string attachment mechanism for holding a length of flight string.

31. A releasable kite, comprising:
a hand controller having a flight string;
a release mechanism attached with the flight string for connecting with a kite, the release mechanism being operable to attach and detach with the kite;
a kite for attaching with the release mechanism, whereby when the kite is attached with the release mechanism, user may fly the kite, and upon detaching from the kite, the kite floats unattached to the ground.

32. A releasable kite as set forth in claim 31, wherein the kite is a parachute-shaped kite.

33. A releasable kite as set forth in claim 32, wherein the release mechanism is a mechanism selected from a group consisting of a timer release mechanism and a wireless release mechanism.

34. A releasable kite as set forth in claim 33, wherein the wireless release mechanism further comprises a wireless controlled releaser and a wireless controller, wherein:
the wireless controlled releaser comprises:
a housing;
a receiver connected with the housing for receiving a wireless signal from a wireless controller;
an actuator attached with the housing and electrically connected with the receiver, the actuator being capable of operating an attachment mechanism through actuation;
an attachment mechanism operably connected with the actuator, the attachment mechanism being configured to open and close upon actuation of the actuator, allowing a user to selectively connect and disconnect a kite; and
wherein the hand controller is the wireless controller configured to selectively send a wireless signal for controlling the wireless controlled releaser, whereby a user may attach a kite with the attachment mechanism and fly the kite, and using the wireless controller, cause the actuator to open the attachment mechanism and thereby release the kite to float freely to the ground.

35. A releasable kite as set forth in claim 34, wherein the attachment mechanism comprises a pair of pivotally connected cooperating jaws.

36. A releasable kite as set forth in claim 35, wherein the wireless controller further includes a flight string attachment mechanism for holding a length of flight string, and wherein the flight string is connected with the wireless controlled releaser.

37. A releasable kite as set forth in claim 33, wherein the timer release mechanism further comprises:
a pair of pivotally connected cooperating jaws that are settable in a closed position; and
a timer for controlling the pivotally connected cooperating jaws, where the pivotally connected cooperating jaws open after a period of time that is set by the timer for releasing a kite, whereby a user may attach a kite with the pivotally connected cooperating jaws such that when the jaws open after the period of time, the kite is released to float unrestrained to the ground.

38. A releasable kite as set forth in claim 37, wherein the timer release mechanism further comprises:
a bottom cap;
a set of secondary timing gear coupled with the pair of pivotally connected cooperating jaws;
a primary timing gear coupled with the secondary timing gear;
a top enclosed cap coupled with the primary timing gear;
a time setting dial coupled with the bottom cap.

39. A releasable kite as set forth in claim 38, further comprising an O-ring attached with the timer release mechanism for affixing with the flight string.
